(19) United States
(12) Patent Application Publication
(10) Pub. No.: US 2012/0104118 A1
(43) Pub. Date: May 3, 2012

(54) Sprinkler adapter device having multiple rates of output flow

(75) Inventors: Po-Hsiung Wang, Chu-Nan Chen (TW); Tzu-Meng Wang, Chu-Nan Chen (TW)

(73) Assignee: KWAN-TEN ENTERPRISE CO., LTD.

(21) Appl. No.: 12/930,092

(22) Filed: Dec. 28, 2010

(30) Foreign Application Priority Data
Nov. 3, 2010 (TW) 099221245

(51) Int. Cl. B05B 1/34

(52) U.S. Cl. 239/380

(57) ABSTRACT

A sprinkler adapter device having multiple rates of output flow of a sprinkler has an inlet-driving unit, an outlet valve and a discharge rotor. The inlet-driving unit has a body and a cover combined with the body, respectively having a first connection portion and a second connection portion communicating with each other. The discharge rotor is collaborated with the outlet valve and is driven by water stream. The discharge rotor and the outlet valve respectively have upper valve holes and lower valve holes corresponding to each other. Each of the upper valve holes and the lower valve holes has a guide plane. By respectively adjusting the overlapping area between the upper valve holes and the lower valve holes and the guide planes thereof, water can be discharged at different flow rates intermittently, thereby simplifying the sprinkler adapter device with a sprinkler and allowing to demonstrate different water spray patterns.

### BACKGROUND OF THE INVENTION

1. Field of the Invention

The present invention relates to a sprinkler adapter device, and more particularly to a sprinkler adapter device applied to a sprinkler and coupled to a water hose to intermittently discharge water at different water flow rates.

2. Description of the Related Art

Sprinkler systems currently applied to gardening have conduits connected to a water source and multiple sprinkler adapters mounted on the conduits and connected to other water manifolds or sprinkler heads so as to spray water over a place that is large in area. Based on the site condition to be deployed and the expected water spray patterns, various sprinkler heads are mounted on conduits that are also connected to a water source to meet a customized requirement. However, technically, such sprinkler adapters only allocate water from the water source to different conduits in the sprinkler systems, and have very limited function and need to be further improved.

### SUMMARY OF THE INVENTION

An objective of the present invention is to provide a sprinkler adapter device able to intermittently discharge water at different water flow rates.

To achieve the foregoing objective, the sprinkler adapter device has an inlet-driving unit, a rotary seat, an outlet valve, a discharge rotor and a cover.

The inlet-driving unit has a body, a spindle and a spin element. The body is hollow and has a chamber and a first connection portion. The chamber is defined in the body. The first connection portion is formed on the body and communicates with the chamber. The spindle is mounted in the chamber. The spin element is rotatably mounted around the spindle.

The rotary seat is hollow, is driven by the spin element to rotate, and has a top board having a shaft hole mounted around the spindle.

The outlet valve is mounted on the spindle and has a disk and multiple lower valve holes. The disk has a top surface. The lower valve holes are formed through the disk and spaced with an interval between each other. Each lower valve hole has an opening and a lower guide plane. The lower guide plane is formed between an inner wall of the lower valve hole and the top surface of the disk. The discharge rotor is connected with the rotary seat to rotate relative to the outlet valve, and has a partition board and multiple upper valve holes. The partition board has a bottom surface. The upper valve holes are formed through the partition board to respectively correspond to the lower valve holes. Each upper valve hole has an opening and an upper guide plane. The upper guide plane is formed between an inner wall of the upper valve hole and the bottom surface of the partition board. A gap formed between each upper guide plane and the partition board communicates with a gap formed between a corresponding lower guide plane and the disk when the upper guide plane overlaps the lower guide plane.

The cover is hollow, and has an end and a second connection portion. The end is mounted on the body. The second connection portion communicates with an inner space of the cover.

After pressurized water flows into the sprinkler adapter device, the water pressure drives the spin element of the inlet-driving unit to rotate with the rotary seat, and synchronously drives the discharge rotor to rotate. With the design of the upper valve holes of the discharge rotor and the lower valve holes of the outlet valve, water can flow through the upper valve holes and the lower valve holes at different flow rates when the portions of the upper valve holes respectively overlapping those of the lower valve holes are varied. When the upper guide planes of the upper valve holes respectively overlap the lower guide planes of the lower valve holes and most of the portions of the upper valve holes respectively misaligning with those of the lower valve holes, only a small amount of water can pass through the lower valve holes and the upper valve holes to the water outlet. Accordingly, when assembled with a sprinkler head, the sprinkler adapter device provides an adequate amount of water for generating different water spray patterns. Additionally, the discharge rotor can be smoothly and steadily rotated relative to the outlet valve.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of sprinkler adapter device having multiple rates of output flow in accordance with the present invention;

FIG. 2 is an exploded perspective view of the sprinkler adapter device having multiple rates of output flow in FIG. 1;

FIG. 3 is another exploded perspective view of the sprinkler adapter device having multiple rates of output flow in FIG. 1;

FIG. 4 is a side view in partial section of the sprinkler adapter device having multiple rates of output flow in FIG. 1;

FIG. 5 is an enlarged operational side view in partial section of a discharge rotor and an outlet valve of the sprinkler adapter device having multiple rates of output flow in FIG. 1;

FIG. 6 is another enlarged operational side view in partial section of the discharge rotor and the outlet valve of the sprinkler adapter device having multiple rates of output flow in FIG. 5;

FIG. 7A is a first operational top view of an upper valve hole of the discharge rotor and a lower valve hole of the outlet valve in FIG. 5;

FIG. 7B is a second operational top view of an upper valve hole of the discharge rotor and a lower valve hole of the outlet valve in FIG. 5;

FIG. 7C is a third operational top view of an upper valve hole of the discharge rotor and a lower valve hole of the outlet valve in FIG. 5;

FIG. 8 is a perspective view of the sprinkler adapter device having multiple rates of output flow in FIG. 1, mounted on a seat;

FIG. 9 is another perspective view of the sprinkler adapter device having multiple rates of output flow in FIG. 1, mounted on a seat and connected with a sprinkler head; and

FIG. 10 is yet another perspective view of the sprinkler adapter device having multiple rates of output flow in FIG. 1, connected with another sprinkler head.

### DETAILED DESCRIPTION OF THE INVENTION

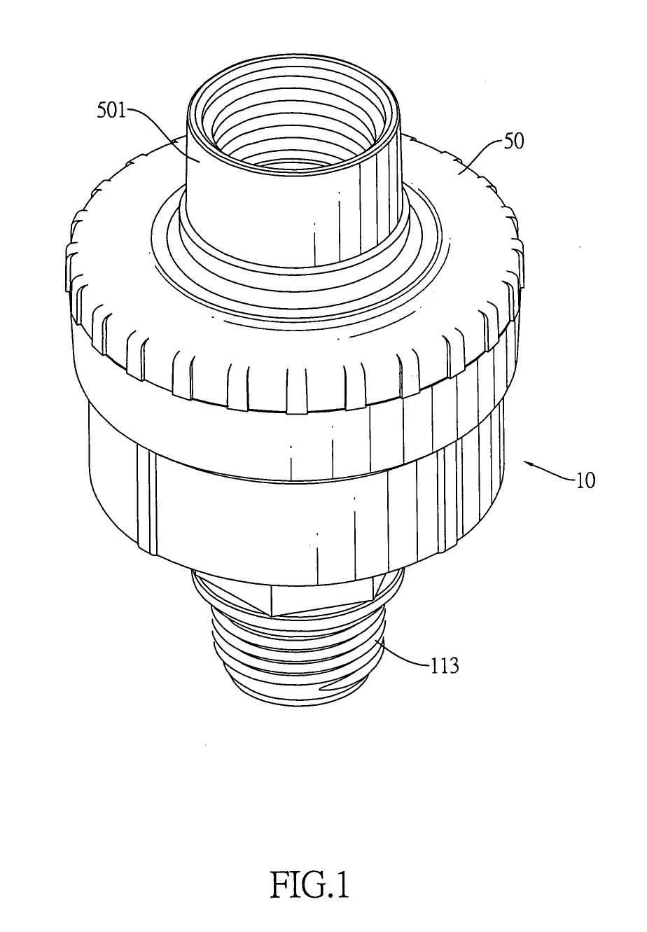

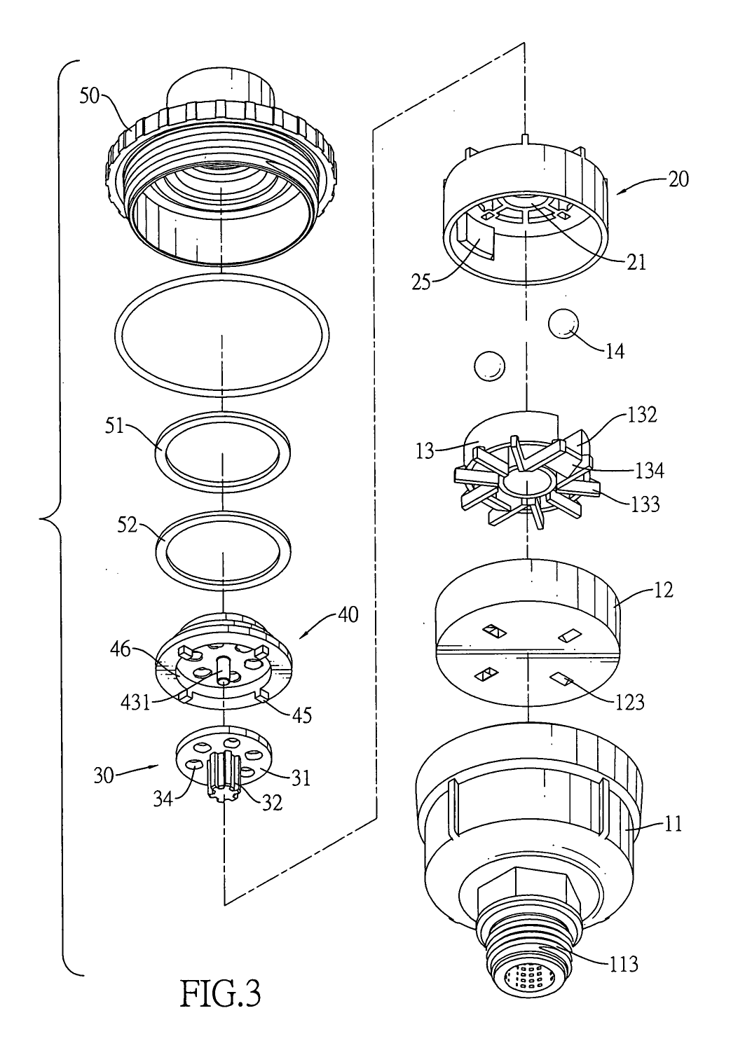

With reference to FIGS. 1 to 3, a sprinkler adapter device having multiple rates of output flow in accordance with the present invention has an inlet-driving unit 10, a rotary seat 20, an outlet valve 30, a discharge rotor 40 and a cover 50.

The inlet-driving unit 10 has a body 11, a shaft seat 12 and a spin element 13. The body 11 is hollow and has a chamber 111, an opening, inner threads, a first connection portion 113, a water inlet 114 and a shoulder 112. The chamber 111 is defined in the body 11. The opening is formed through a top of the body 11 and communicates with the chamber 111. The inner threads are formed on an inner wall of the body 11 and extend downwardly from the opening. The first connection portion 113 is formed on a lower portion of the body 11, is reduced in diameter relative to the body 11, and has threads formed around a periphery of the first connection portion 113. The water inlet 114 is formed through a bottom of the first connection portion 113 and communicates with the chamber 111. The shoulder 112 is formed on an inner wall of the body 11 and is adjacent to the first connection portion 113.

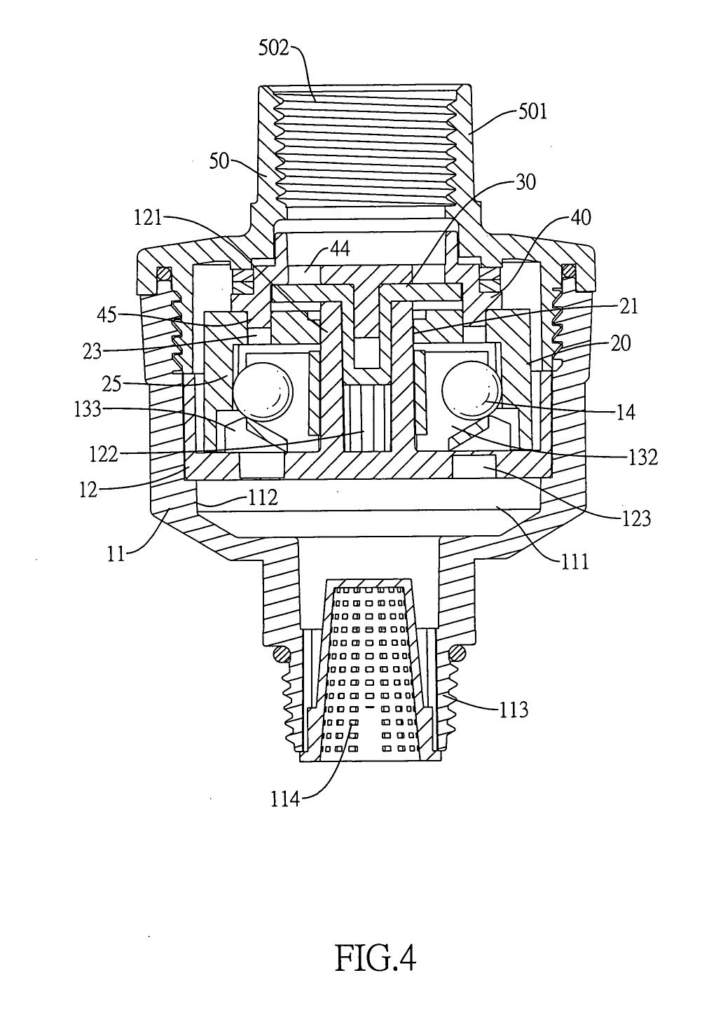

The shaft seat 12 is hollow and has a bottom board, a sidewall, a spindle 121, a positioning hole 122 and multiple water holes 123. With further reference to FIG. 4, the bottom board is mounted and positioned on the shoulder 112 of the body 13. The sidewall is formed around a perimeter of the bottom board. The spindle 121 is centrally formed on and protrudes upwardly from the bottom board. The positioning hole 122 is formed in a top of the spindle 121 and has a non-circular section. The water holes 123 are formed obliquely through the bottom board, so that an angle is defined between the axis of each water hole 123 and that of the bottom board.

The spin element 13 is annular and has a board, multiple annular walls formed around a perimeter of the board, a shaft hole 131, multiple passages 135, two slots 132, multiple blades 133, two guide pieces 134 and two driving elements 14. The shaft hole 131 is centrally and axially formed through the board of the spin element 13 and is mounted around the spindle 121 of the shaft seat 12. The passages 135 are circumferentially formed through the spin element 13 and around the shaft hole 131. The slots 132 are oppositely formed through the board of the spin element 13. The blades 133 are radially and separately formed on a bottom of the spin element 13 and respectively correspond to the water holes 123 of the shaft seat 12. Each guide piece 134 is formed inside one of the slots 132 and extends obliquely and upwardly from the board of the spin element 13. Each driving element 14 may be a metal ball and is received in one of the slots 132 and on a corresponding guide piece 134.

The rotary seat 20 is hollow and has a top board and an annular wall formed around a perimeter of the top board, an outer diameter smaller than an inner diameter of the shaft seat 12, multiple top bars 22, a shaft hole 21, multiple locating holes 23, multiple through holes 24 and two push blocks 25. The top bars 22 are radially formed on and protrude upwardly from the top board. The shaft hole 21 is centrally formed through the top board. Each locating hole 23 is formed through one of the top bars 22 and is adjacent to the shaft hole 21. The through holes 24 are formed through the top board of the rotary seat 20 and each through hole 24 is formed between two adjacent top bars 22. The push blocks 25 are oppositely formed on and protrude from an inner wall of the annular wall of the rotary seat 20. Because the shaft hole 21 of the rotary seat 20 is mounted around the spindle 121 of the shaft seat 12 and the spin element 13 is received in the rotary seat 20, the push blocks 25 respectively correspond to the slots 132 and the driving elements 14 of the spin elements 13. When each driving element 14 centrifugally and outwardly abuts a corresponding push block 25, the rotary seat 20 is selectively rotated synchronously with the spin element 13 when the driving elements 14 respectively abut against the push blocks 25, or stays still when the driving elements 14 and the push blocks 25 are separated.

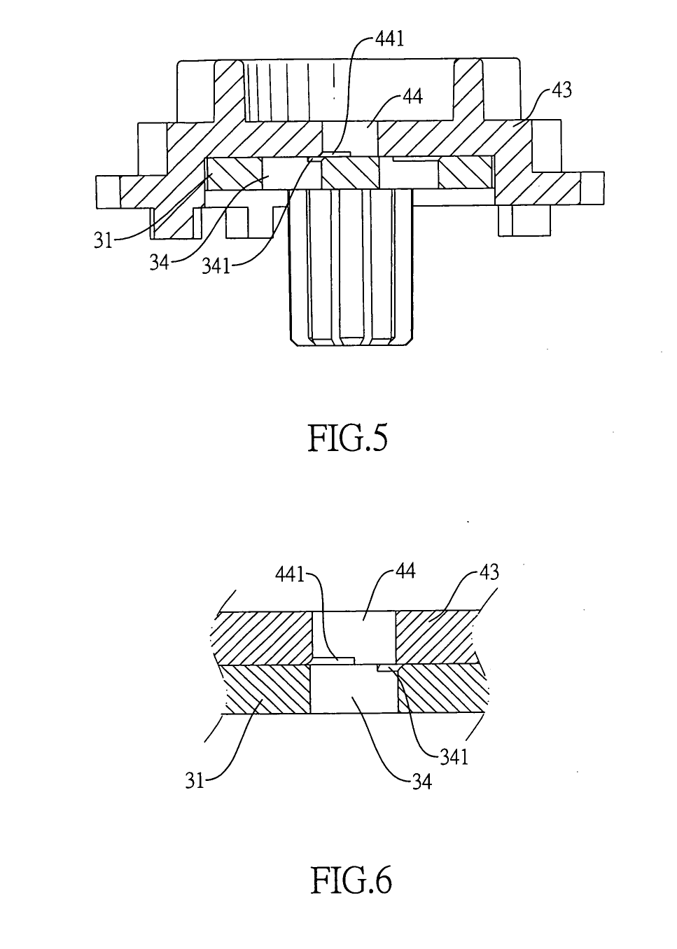

The outlet valve 30 has a disk 31, a shaft column 32, a rod hole 33 and multiple lower valve holes 34. The shaft column 32 is formed on and protrudes downwardly from a bottom of the disk, has a non-circular cross section corresponding to that of the positioning hole 122,and is mounted in the positioning hole 122 of the spindle 121. The rod hole 33 is centrally formed through the disk 31 and formed in the shaft column 32. The lower valve holes 34 are circumferentially formed through the disk and spaced at an equal distance apart from a rotation center of the shaft column 32. With reference to FIGS. 5 and 6, each lower valve hole 34 has a lower guide plane 341 formed between an inner wall of the lower valve hole 34 and a top surface of the disk 31. The lower guide plane 341 may be a chamfer plane.

The discharge rotor 40 has a partition board 43, multiple upper valve holes 44, a collar 42, and a flange 41. The partition board 43 has a center rod 431 centrally formed on and protruding from a bottom surface of the partition board 43, and is rotatably mounted in the rod hole 33 of the outlet valve 30. The upper valve holes 44 are circumferentially formed through the partition board 43 and spaced at an equal distance apart from a rotation center of the center rod 431 to respectively correspond to the lower valve holes 34. The distance from the rotation center of the center rod 431 to each of the upper valve holes 44 is equal to that from the rotation center of the shaft column 32 to a corresponding lower valve hole 34. Each upper valve hole 44 has an upper guide plane 441 formed between an inner wall of the upper valve hole 44 and the bottom surface of the partition board 43. The upper guide plane 441 may be a chamfer plane. The upper guide plane 441 of each upper valve hole 44 is opposite to the lower guide plane 341 of the corresponding lower valve hole 34 when the upper valve hole 44 coincides with the lower valve hole 34. The collar 42 is annularly formed on and protrudes from the partition board 43. The flange 41 is formed on and protrudes outwardly from the bottom of the partition board 43, and has multiple engagement blocks 45 and a recess 46. The engagement blocks 45 are formed on and protrude from a bottom of the flange 41 and respectively engage the locating holes 23 of the rotary seat 20 so that the discharge rotor 40 and the rotary seat 20 can rotate simultaneously. The recess 46 is formed in a bottom of the flange 41 to receive the disk 31 of the outlet valve 30, and communicates with the upper valve holes 44.

When the discharge rotor 40 is rotated relative to the outlet valve 30, a front portion between the top surface of the disk 31 and each of the upper valve holes 44 and the lower valve holes 34 in the rotation direction is defined as a front hole edge, and an opposite portion to the front portion is defined as a rear hole edge. In the present embodiment, the upper guide plane 441 of each of the upper valve holes 44 is formed on a corresponding front hole edge and the lower guide plane 341 of each of the lower valve holes 34 is formed on a corresponding rear hole edge.

Furthermore, preferably, a ratio between a longitudinal height of the upper guide plane 441 of each upper valve hole 44 and that of the lower guide plane 341 of a corresponding lower valve hole 43 is 3:4. A length of each of the upper guide planes 441 formed around an opening of a corresponding upper valve hole 44 is less than one half of the perimeter of the opening of the upper valve hole 44. A length of each of the lower guide planes 341 formed around an opening of a corresponding lower valve hole 34 is less than one half of the perimeter of the opening of the lower valve hole 34.

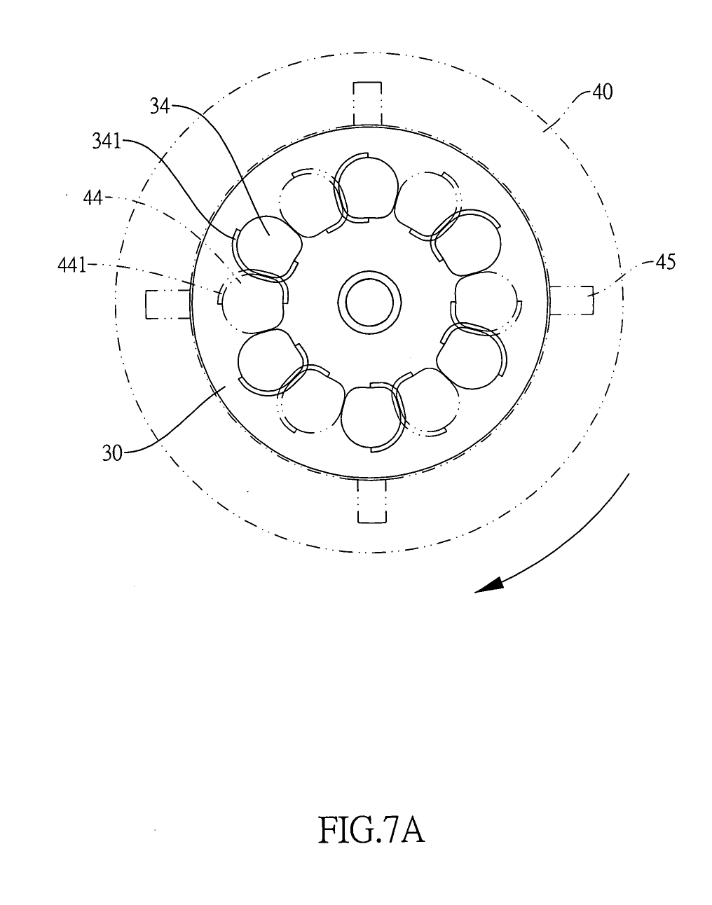

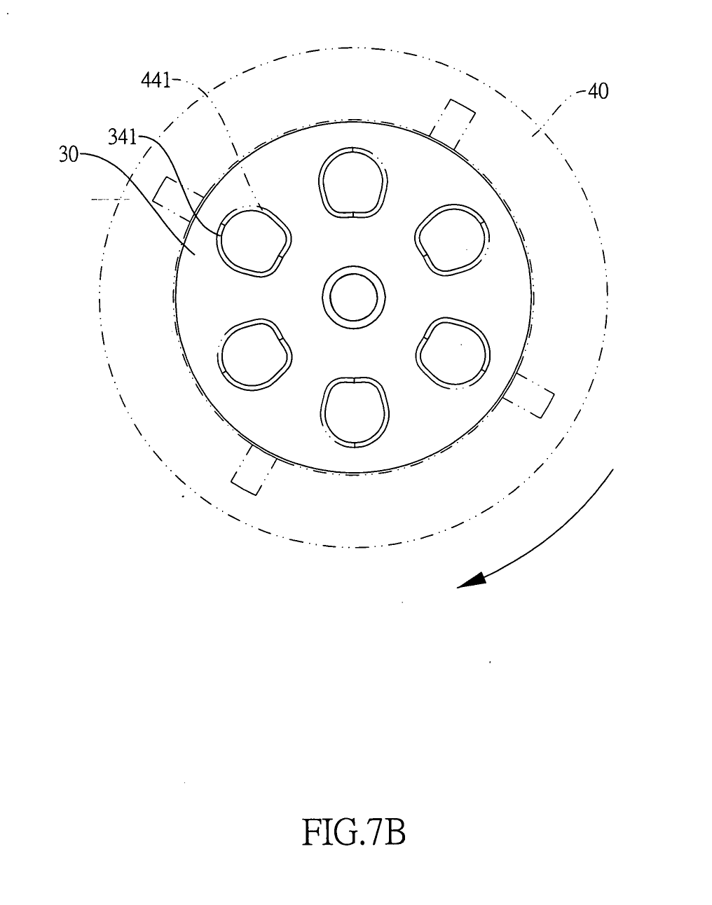

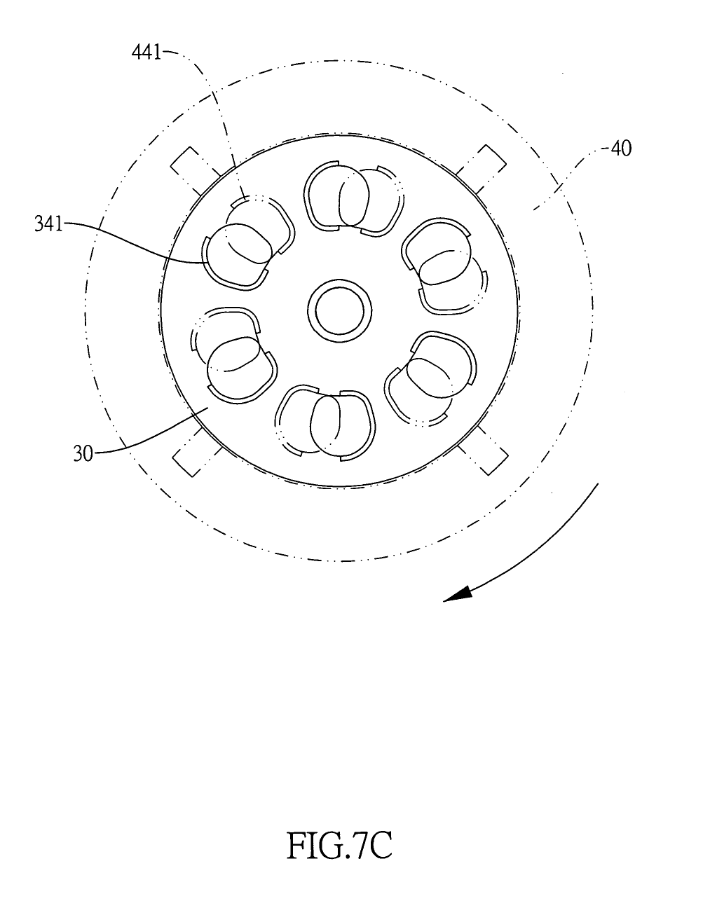

With reference to FIG. 7A, when the discharge rotor 40 is rotated clockwise relative to the outlet valve 30 and the upper guide planes 441 respectively align with the corresponding lower guide planes 341, small edge portions of the openings of the upper valve holes 44 and the lower valve holes 34 are overlapped. However, a gap formed between each upper guide plane 441 and the partition board 43 communicates with a gap formed between a corresponding lower guide plane 341 and the disk 31 so that water flows through the lower valve holes 34, the lower guide planes 341 and the upper guide planes 441 to the upper valve holes 44 at a low flow rate.

After the discharge rotor 40 is further rotated clockwise relative to the outlet valve 30 and the upper valve holes 44 and the lower valve holes 34 are partially overlapped, the water flow rate flowing from each of the lower valve holes 34 to a corresponding upper valve hole 44 increases. With reference to FIG. 7B, when the discharge rotor 40 is further rotated clockwise relative to the outlet valve 30 and each of the lower valve holes 34 aligns with a corresponding upper valve hole 44, water directly flows from the lower valve holes 34 to the upper valve holes 44 at a high flow rate.

With reference to FIG. 7C, when the discharge rotor 40 is further rotated clockwise relative to the outlet valve 30 and the overlapped portion of each of the upper valve holes 44 and a corresponding lower valve hole 34 decreases, water directly flows from the lower valve holes 34 to the upper valve holes 44 at a medium flow rate.

With further reference to FIG. 7A, when the discharge rotor 40 is rotated clockwise relative to the outlet valve 30 and the upper guide planes 441 respectively align with the corresponding lower guide planes 341 again, water flows through the lower valve holes 34, the lower guide planes 341 and the upper guide planes 441 to the upper valve holes 44 back at a low flow rate.

The cover 50 is hollow, takes a form of an annulus, and has a base portion, threads, a second connection portion 501, a water outlet 502, a first O-ring 51 and a second O-ring 52. The base portion is annular and hollow. The threads are formed on a periphery of the base portion. The second connection portion 501 is formed on and protrudes upwardly and centrally from the base portion, and is reduced in diameter relative to the base portion. The water outlet 502 is formed through the second connection portion 501 and has a bore diameter corresponding to an inner diameter of the collar 42 of the discharge rotor 40. The second O-ring 52 and the first O-ring 51 are sequentially mounted on the flange 41 of the discharge rotor 40. The second O-ring 52 and the first O-ring 51 may be made of polytetrafluoroethylene (PTFE or teflon), i.e. a wear-resistant material, and a waterproof material respectively. When the threads on the base portion of the cover 50 are screwed into the inner threads at the opening of the body 13, an inner side of the cover 50 abuts against the first O-ring 52 and the second O-ring 51. The second connection portion 501 may have threads formed on an inner wall of the second connection portion 501 or on a periphery of the second connection portion 501.

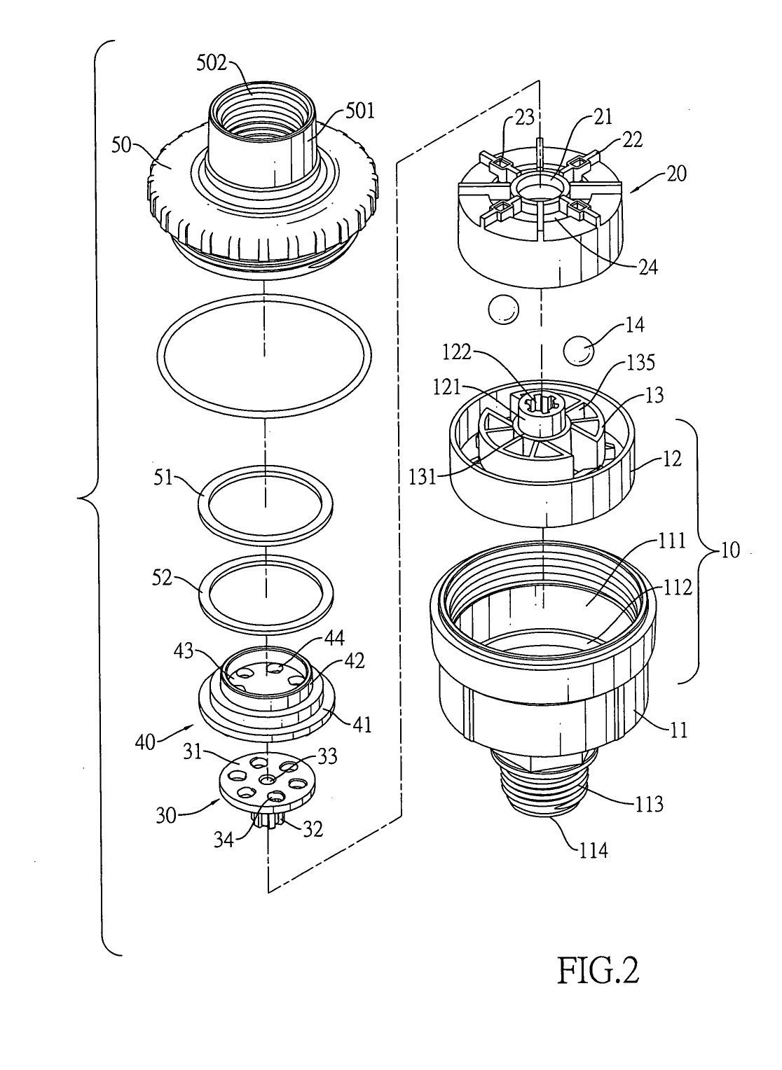

With reference to FIGS. 2 to 4, when the discharge assembly is operated, pressurized water enters the chamber 111 of the body 10 through the water inlet 114 of the body. Water further passes through the water holes 123 of the shaft seat 12 and propels the blades 133 of the spin element 13 to rapidly spin the spin element 13. A centrifugal force as a result of the rapid rotation of the spin element 13 moves the driving element 14 in a corresponding slot 132 obliquely and upwardly along the guide piece 134 to abut against an inner wall of the rotary seat 20. When each driving element 14 abuts against a corresponding push block 25 on the inner wall of the rotary seat 20, the rotary seat 20 is rotated with the spin element 13. Meanwhile, water is also filled in the chamber 111 between the body 11 and the cover 50, and the corresponding parts including the shaft seat 12, the spin element 13, the rotary seat 20 and the outlet valve 30 to maintain a consistent pressure everywhere inside the sprinkler device so that the rotary seat 20 and the discharge rotor 40 are smoothly rotated when being driven to rotate.

With reference to FIGS. 5 and 6, when each upper valve hole 44 on the partition board 43 of the outlet valve 40 corresponds to and aligns with a corresponding lower valve hole 34 on the disk 31 of the outlet valve 30, pressurized water rapidly flows through the lower valve holes 34 and the upper valve holes 44 to the water outlet 502 of the cover 50 at a high flow rate as shown in FIG. 7B. When each upper valve hole 44 of the partition board 43 is further rotated relative to a corresponding lower valve hole 34 and the upper valve hole 44 gradually departs from the opening of the lower valve hole 34 as shown in FIG. 7C, pressurized water flows through the lower valve holes 34 and the upper valve holes 44 to the water outlet 502 of the cover 50 at a medium flow rate. When each upper valve hole 44 of the partition board 43 is further rotated relative to a corresponding lower valve hole 34 and the upper guide plane 441 of each upper valve hole 44 overlaps the lower guide plane 341 of the lower valve hole 34, pressurized water flows through the lower valve holes 34, the gap formed between the lower guide plane 341 and the upper guide plane 441, and the upper valve holes 44 to the water outlet 502 of the cover 50 at a low flow rate. Despite a low flow rate, water flow is not fully blocked and a small amount of water still flows through the discharge rotor 40 to the water outlet 502 of the cover 50. With the upper valve holes 44 of the discharge rotor 40 and the lower valve holes 34 of the outlet valve and the alignment of the upper guide planes 441 and the lower guide planes 341, water can flow out of the water outlet of the cover at different flow rates.

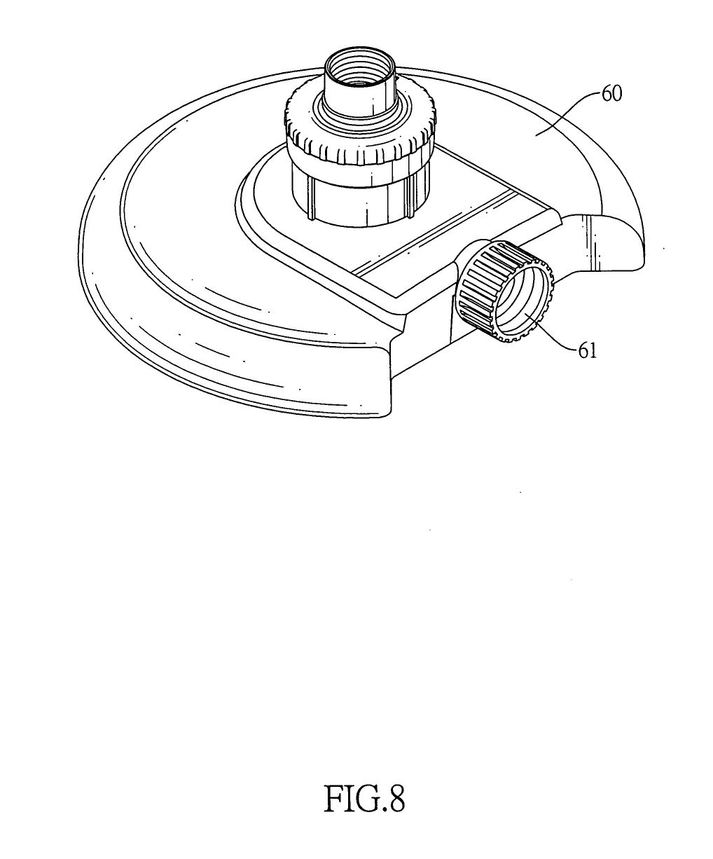

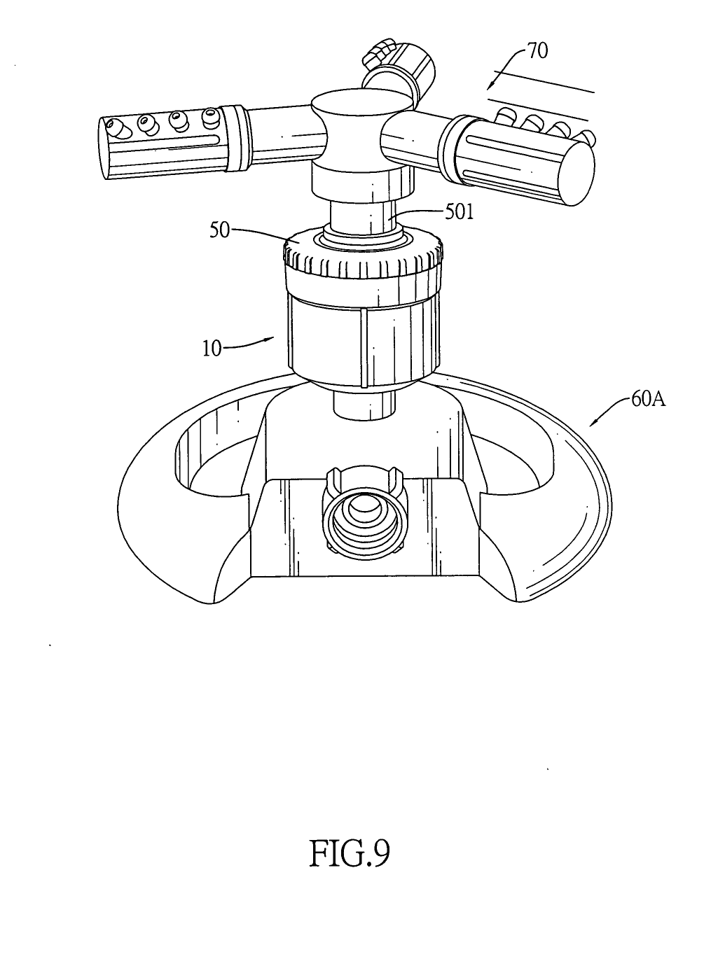

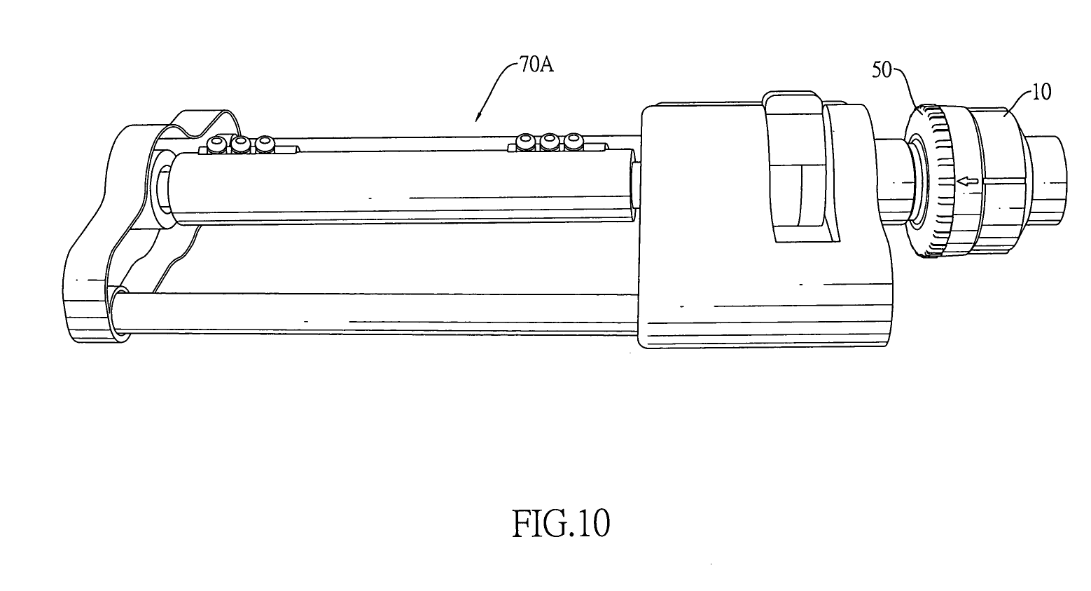

With reference to FIG. 8, the sprinkler adapter device can be mounted on a seat 60. The seat 60 has a water inlet 61 and a mounting connector. The water inlet 61 is formed on one end of the seat 60 to connect to a water source. The mounting connector is formed on another end for mounting the first connecting portion 113 of the sprinkler adapter device on the seat 60. The body of the sprinkler adapter device may be integrally formed on the seat 60. Hence, water flowing from the water source can enter the body 11 through the water inlet 61. With reference to FIG. 9, a sprinkler head 70 may be mounted on the second connection portion 501 of the cover 50. With reference to FIG. 10, another type of sprinkler head 70A may be mounted on the second connection portion 501 of the cover 50. The sprinkler adapter device of the present invention can be adapted to meet the varied mounting situations for various sprinkler systems in practice.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A sprinkler adapter device having multiple rates of output flow of a sprinkler comprising:
an inlet-driving unit having:
a body being hollow and having:
a chamber defined in the body; and
a first connection portion formed on the body and communicating with the chamber;
a spindle mounted in the chamber; and
a spin element rotatably mounted around the spindle;
a rotary seat being hollow, driven by the spin element to rotate, and having a top board having a shaft hole mounted around the spindle;
an outlet valve mounted on the spindle and having:
a disk having a top surface; and
multiple lower valve holes formed through the disk and spaced with an interval between each other, each lower valve hole having:
an opening; and
a lower guide plane formed between an inner wall of the lower valve hole and the top surface of the disk;
a discharge rotor connected with the rotary seat to rotate relative to the outlet valve, and having:
a partition board having a bottom surface; and
multiple upper valve holes formed through the partition board to respectively correspond to the lower valve holes, each upper valve hole having:
an opening; and
an upper guide plane formed between an inner wall of the upper valve hole and the bottom surface of the partition board, wherein a gap formed between each upper guide plane and the partition board communicates with a gap formed between a corresponding lower guide plane and the disk when the upper guide plane overlaps the lower guide plane; and
a cover being hollow, and having:
an end mounted on the body; and
a second connection portion communicating with an inner space of the cover.

2. The sprinkler adapter device having multiple rates of output flow as claimed in claim 1, wherein when the discharge rotor is rotated relative to the outlet valve, a front portion between the top surface of the disk and each of the upper valve holes and the lower valve holes in the rotation direction is defined as a front hole edge, and an opposite portion to the front portion is defined as a rear hole edge, the upper guide plane of each of the upper valve holes is formed on a corresponding front hole edge and the lower guide plane of each of the lower valve holes is formed on a corresponding rear hole edge.

3. The sprinkler adapter device having multiple rates of output flow as claimed in claim 1, wherein a ratio between a longitudinal height of the upper guide plane of each upper valve hole and that of the lower guide plane of a corresponding lower valve hole is 3:4.

4. The sprinkler adapter device having multiple rates of output flow as claimed in claim 2, wherein a ratio between a longitudinal height of the upper guide plane of each upper valve hole and that of the lower guide plane of a corresponding lower valve hole is 3:4.

5. The sprinkler adapter device having multiple rates of output flow as claimed in claim 1, wherein
a length of each of the upper guide planes formed around the opening of a corresponding upper valve hole is less than one half of a perimeter of the opening of the upper valve hole; and
a length of each of the lower guide planes formed around an opening of a corresponding lower valve hole is less than one half of a perimeter of the opening of the lower valve hole.

6. The sprinkler adapter device having multiple rates of output flow as claimed in claim 2, wherein
a length of each of the upper guide planes formed around the opening of a corresponding upper valve hole is less than one half of a perimeter of the opening of the upper valve hole; and
a length of each of the lower guide planes formed around an opening of a corresponding lower valve hole is less than one half of a perimeter of the opening of the lower valve hole.

7. The sprinkler adapter device having multiple rates of output flow as claimed in claim 3, wherein
a length of each of the upper guide planes formed around the opening of a corresponding upper valve hole is less than one half of a perimeter of the opening of the upper valve hole; and
a length of each of the lower guide planes formed around an opening of a corresponding lower valve hole is less than one half of a perimeter of the opening of the lower valve hole.

8. The sprinkler adapter device having multiple rates of output flow as claimed in claim 4, wherein
a length of each of the upper guide planes formed around the opening of a corresponding upper valve hole is less than one half of a perimeter of the opening of the upper valve hole; and
a length of each of the lower guide planes formed around an opening of a corresponding lower valve hole is less than one half of a perimeter of the opening of the lower valve hole.

9. The sprinkler adapter device having multiple rates of output flow as claimed in claim 5, wherein the lower guide plane of each lower valve hole and the upper guide plane of each upper hole are chamfer planes.

10. The sprinkler adapter device having multiple rates of output flow as claimed in claim 6, wherein the lower guide plane of each lower valve hole and the upper guide plane of each upper hole are chamfer planes.

11. The sprinkler adapter device having multiple rates of output flow as claimed in claim 7, wherein the lower guide plane of each lower valve hole and the upper guide plane of each upper hole are chamfer planes.

12. The sprinkler adapter device having multiple rates of output flow as claimed in claim 8, wherein the lower guide plane of each lower valve hole and the upper guide plane of each upper hole are chamfer planes.

13. The sprinkler adapter device having multiple rates of output flow as claimed in claim 1, wherein
the first connection portion of the body has:
a periphery;
an inner wall;
threads formed on the periphery of the first connection portion; and
a water inlet formed through the first connection portion and communicating with the chamber;
the second connection portion of the cover has:
an inner wall;
a periphery;
a water outlet formed through the second connection portion; and
threads formed on the inner wall of the second connection portion.

14. The sprinkler adapter device having multiple rates of output flow as claimed in claim 13, wherein
the spindle has a positioning hole formed in a top of the spindle;
the outlet valve further has:
a shaft column formed on and protruding downwardly from a bottom of the disk, and mounted in the positioning hole of the spindle; and
a rod hole centrally formed through the disk and formed in the shaft column;
the rotary seat further has:
an annular wall formed around a perimeter of the top board;
multiple top bars radially formed on and protruding upwardly from the top board.;
multiple locating holes, each locating hole formed through one of the top bars and being adjacent to the shaft hole;
multiple through holes formed through the top board, each through hole formed between two adjacent top bars,
wherein the shaft hole is centrally formed through the top board;
the partition board further has:
a center rod centrally formed on and protruding from the bottom surface of the partition board, and rotatably mounted in the rod hole of the outlet valve; and
multiple engagement blocks formed on and protruding from the partition board to respectively correspond to and engage the locating holes of the rotary seat.

15. The sprinkler adapter device having multiple rates of output flow as claimed in claim 14, wherein
the body further has a shoulder formed on and protruding from an inner wall of the body and being adjacent to the first connection portion; and
the inlet-driving unit further has a shaft seat being hollow and mounted in the shoulder and having:
a bottom board positioned on the shoulder of the body;
a sidewall formed around a perimeter of the bottom board; and
multiple water holes formed obliquely through the bottom board, so that an angle is defined between the axis of each water hole and that of the bottom board.

16. The sprinkler adapter device having multiple rates of output flow as claimed in claim 15, wherein the spin element is hollow and has:
a bottom;
a board;
multiple annular walls formed around a perimeter of the board,
a shaft hole centrally and axially formed through the board and mounted around the spindle of the shaft seat;
multiple passages circumferentially formed through the spin element and around the shaft hole;
two slots being oppositely formed through the board of the spin element;
multiple blades radially and separately formed on the bottom of the spin element and respectively corresponding to the water holes of the shaft seat;
two guide pieces, each guide piece formed inside one of the slots and extending obliquely and upwardly from the board; and
two driving elements, each driving element received in one of the slots and on a corresponding guide piece.

17. The sprinkler adapter device having multiple rates of output flow as claimed in claim 16, wherein
the discharge rotor further has:
a collar annularly formed on and protruding from the partition board to correspond to the water outlet of the second connection portion; and
a flange formed on and protruding outwardly from the bottom of the partition board; and
the cover further has two O-rings mounted on the flange of the discharge rotor, located between the cover and the outlet valve, and respectively made of two different materials.
